(19) United States
(12) Patent Application Publication
(10) Pub. No.: US 2025/0071259 A1
(43) Pub. Date: Feb. 27, 2025

(54) INTRA PREDICTION WITH MULTIPLE REFERENCE LINES

(71) Applicant: GUANGDONG OPPO MOBILE TELECOMMUNICATIONS CORP., LTD., Dongguan (CN)

(72) Inventors: Kazushi SATO, Palo Alto, CA (US); Yue YU, Palo Alto, CA (US); Haoping YU, Palo Alto, CA (US)

(21) Appl. No.: 18/725,337

(22) PCT Filed: Dec. 27, 2022
(86) PCT No.: PCT/US2022/082418

§ 371 Date: Jun. 28, 2024

Related U.S. Application Data
(60) Provisional application No. 63/266,093, filed on Dec. 28, 2021.
(60) Provisional application No. 63/266,095, filed on Dec. 28, 2021.

(51) Int. Cl. H04N 19/105; H04N 19/174; H04N 19/176; H04N 19/70

(52) U.S. Cl. CPC H04N 19/105; H04N 19/174; H04N 19/176; H04N 19/70

(57) ABSTRACT

A system includes a processor and a non-transitory computer readable medium in communication with the processor, the non-transitory computer readable medium having encoded thereon a set of instructions executable by the processor to determine intra prediction information of a current block, obtain a multiple reference line (MRL) index from the plurality of syntax elements, decode a first candidate reference line and a second candidate reference line based, at least in part, on the MRL index, and generate a prediction block based, at least in part, on intra prediction performed based on the plurality of syntax elements.

### CROSS-REFERENCE TO RELATED APPLICATIONS

This application claims priority to U.S. Provisional Patent Application Ser. No. 63/266,093 (the “'093 Application”), filed Dec. 28, 2021, by Kazushi Sato et al., entitled, “INTRA PREDICTION MODE CODING WITH MULTIPLE REFERENCE LINES,” and U.S. Provisional Patent Application Ser. No. 63/266,095 (the “'095 Application”), filed Dec. 28, 2021, by Kazushi Sato et al., entitled, “INTRA PREDICTION METHOD WITH MULTIPLE REFERENCE LINES,” the disclosures of which are incorporated herein by reference in its entirety for all purposes.

### FIELD

The present disclosure relates, in general, to methods, systems, and apparatuses for multimedia encoding and decoding.

### BACKGROUND

Versatile Video Coding (VVC) is a video coding standard that offers improved performance and efficiency over preceding standards, such as Advanced Video Coding (AVC) and High Efficiency Video Coding (HEVC). Intra prediction is a technique in video compression in which blocks of pixels are predicted based on neighboring pixels, allowing prediction errors to be transmitted instead of pixel values. In addition to a directly adjacent line of neighboring samples, one of the two non-adjacent reference lines may be used in intra prediction. The use of non-adjacent reference lines is referred to as multiple reference line (MRL) prediction. Conventionally, in VVC, MRL is disabled and not signaled for coding units (CU) at the top of a coding tree unit (CTU), and only applied when an intra prediction mode of most probable mode (MPM) is coded, and further excluding Planar Mode.

Thus, an expanded framework for implementing intra prediction with MRL is set forth in the embodiments below.

### SUMMARY

Tools and techniques for intra prediction with MRL are provided.

A method includes determining intra prediction information of a current block, wherein the intra prediction information includes a plurality of syntax elements, obtaining a multiple reference line (MRL) index from the plurality of syntax elements, and decoding a first candidate reference line and a second candidate reference line based, at least in part, on the MRL index, wherein the first candidate reference line is one of a set of one or more above neighboring reference lines, wherein the second candidate reference line is one of a set of one or more left neighboring reference lines. The method further includes generating a prediction block based, at least in part, on intra prediction performed based on the plurality of syntax elements.

An apparatus includes a non-transitory computer readable medium in communication with the processor, the non-transitory computer readable medium having encoded thereon a set of instructions executable by the processor to perform various functions. The set of instructions may be executable by the processor to determine intra prediction information of a current block, wherein the intra prediction information includes a plurality of syntax elements, obtain a MRL index from the plurality of syntax elements, and decode a first candidate reference line and a second candidate reference line based, at least in part, on the MRL index. The first candidate reference line may be one of a set of one or more above neighboring reference lines, and the second candidate reference line may be one of a set of one or more left neighboring reference line. The set of instructions may further be executed by the processor to generate a prediction block based, at least in part, on intra prediction performed based on the plurality of syntax elements.

A system includes a processor, and a non-transitory computer readable medium in communication with the processor, the non-transitory computer readable medium having encoded thereon a set of instructions executable by the processor to perform various processes. The set of instructions is executable by the processor to determine intra prediction information of a current block, wherein the intra prediction information includes a plurality of syntax elements, obtain a MRL index from the plurality of syntax elements, and select a first candidate reference line and a second candidate reference line based, at least in part, on the MRL index. The first candidate reference line may be one of a set of one or more above neighboring reference lines, and the second candidate reference line may be one of a set of one or more left neighboring reference line. The set of instructions may further be executed by the processor to generate a prediction block based, at least in part, on intra prediction performed based on the plurality of syntax elements.

These illustrative embodiments are mentioned not to limit or define the disclosure, but to provide examples to aid understanding thereof. Additional embodiments are discussed in the Detailed Description, and further description is provided therein.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram of a coding tree unit (CTU), in accordance with various embodiments;

FIG. 2 is a schematic diagram of a CTU divided into multiple coding units (CU), in accordance with various embodiments;

FIG. 3 is a schematic diagram of a framework for intra prediction with MRL, in accordance with various embodiments;

FIG. 4A is a schematic diagram of a framework for intra prediction with MRL with increased buffer lines, in accordance with various embodiments;

FIG. 4B is a schematic diagram of intra prediction with MRL at a top boundary of a CTU, in accordance with various embodiments;

FIG. 5 is a flow diagram of intra prediction with MRL, in accordance with various embodiments;

FIG. 6 is a block diagram of a media encoding system, in accordance with various embodiments;

FIG. 7 is a block diagram of a media decoding system, in accordance with various embodiments;

FIG. 8 is a schematic block diagram of a computer system for intra prediction with MRL, in accordance with various embodiments.

### DETAILED DESCRIPTION

Various embodiments provide tools and techniques for intra prediction with MRL.

In some embodiments, a method for intra prediction with MRL is provided. A method includes determining intra prediction information of a current block, wherein the intra prediction information includes a plurality of syntax elements, obtaining a MRL index from the plurality of syntax elements, and decoding a first candidate reference line and a second candidate reference line based, at least in part, on the MRL index, wherein the first candidate reference line is one of a set of one or more above neighboring reference lines, wherein the second candidate reference line is one of a set of one or more left neighboring reference lines. The method further includes generating a prediction block based, at least in part, on intra prediction performed based on the plurality of syntax elements.

In some examples, determining intra prediction information may include determining an intra prediction mode of the current block. In some examples, the intra prediction mode is an angular intra prediction mode. The method may further comprise mapping pixels of the first candidate reference line to the second candidate reference line. In some examples, the intra prediction mode may be one of a primary most probable mode or secondary most probable mode.

In some examples, the method may further include determining a maximum number of reference lines to be used for intra prediction based on the plurality of syntax elements. In some examples, determining the maximum number of reference lines may further include determining a maximum number of reference lines in the set of one or more above neighboring reference lines, and determining a maximum number of reference lines in the set of one or more left neighboring reference lines.

In some examples, the MRL index further comprises an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines. In some further examples, a first range of MRL index values may correspond to the first candidate reference line.

In some embodiments, an apparatus for intra prediction with MRL is provided. An apparatus includes a non-transitory computer readable medium in communication with the processor, the non-transitory computer readable medium having encoded thereon a set of instructions executable by the processor to perform various functions. The set of instructions may be executable by the processor to determine intra prediction information of a current block, wherein the intra prediction information includes a plurality of syntax elements, obtain a MRL index from the plurality of syntax elements, and decode a first candidate reference line and a second candidate reference line based, at least in part, on the MRL index. The first candidate reference line may be one of a set of one or more above neighboring reference lines, and the second candidate reference line may be one of a set of one or more left neighboring reference line. The set of instructions may further be executed by the processor to generate a prediction block based, at least in part, on intra prediction performed based on the plurality of syntax elements.

In some examples, determining intra prediction information may include determining an intra prediction mode of the current block. In some examples, the intra prediction mode may be an angular intra prediction mode, wherein the set of instructions is further executable by the processor to map pixels of the first candidate reference line to the second candidate reference line. In some examples, the intra prediction mode may be one of a primary most probable mode or secondary most probable mode.

In some examples, the set of instructions is further executable by the processor to determine a maximum number of reference lines to be used for intra prediction based on the plurality of syntax clements. In some examples, determining the maximum number of reference lines may include determining a maximum number of reference lines in the set of one or more above neighboring reference lines, and determining a maximum number of reference lines in the set of one or more left neighboring reference lines.

In some examples, the MRL index further includes an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines. In some examples, a first range of MRL index values may correspond to the first candidate reference line.

In further embodiments, a system for intra prediction with MRL is provided. A system includes at least one of an encoder or decoder, wherein the at least one of the encoder or decoder includes a processor, and a non-transitory computer readable medium in communication with the processor, the non-transitory computer readable medium having encoded thereon a set of instructions executable by the processor to perform various processes. The set of instructions is executable by the processor to determine intra prediction information of a current block, wherein the intra prediction information includes a plurality of syntax elements, obtain a MRL index from the plurality of syntax elements, and select a first candidate reference line and a second candidate reference line based, at least in part, on the MRL index. The first candidate reference line may be one of a set of one or more above neighboring reference lines, and the second candidate reference line may be one of a set of one or more left neighboring reference line. The set of instructions may further be executed by the processor to generate a prediction block based, at least in part, on intra prediction performed based on the plurality of syntax elements.

In some examples, the intra prediction mode may be a secondary most probable mode. In some examples, the MRL index may further include an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines. In some further examples, a first range of MRL index values may correspond to the first candidate reference line.

In the following description, for the purposes of explanation, numerous details are set forth to provide a thorough understanding of the described embodiments. It will be apparent to one skilled in the art, however, that other embodiments may be practiced without some of these details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

When an element is referred to herein as being “disposed” in some manner relative to another element (e.g., disposed on, disposed between, disposed under, disposed adjacent to, or disposed in some other relative manner), it is to be understood that the clements can be directly disposed relative to the other element (e.g., disposed directly on another element), or have intervening elements present between the elements. In contrast, when an element is referred to as being “disposed directly” relative to another element, it should be understood that no intervening elements are present in the “direct” example. However, the existence of a direct disposition does not exclude other examples in which intervening elements may be present.

Similarly, when an element is referred to herein as being “bonded” to another element, it is to be understood that the elements can be directly bonded to the other element (without any intervening elements) or have intervening elements present between the bonded elements. In contrast, when an element is referred to as being “directly bonded” to another clement, it should be understood that no intervening elements are present in the “direct” bond between the elements. However, the existence of direct bonding does not exclude other forms of bonding, in which intervening elements may be present.

Likewise, when an element is referred to herein as being a “layer,” it is to be understood that the layer can be a single layer or include multiple layers. For example, a conductive layer may comprise multiple different conductive materials or multiple layers of different conductive materials, and a dielectric layer may comprise multiple dielectric materials or multiple layers of dielectric materials. When a layer is described as being coupled or connected to another layer, it is to be understood that the coupled or connected layers may include intervening clements present between the coupled or connected layers. In contrast, when a layer is referred to as being “directly” connected or coupled to another layer, it should be understood that no intervening elements are present between the layers. However, the existence of directly coupled or connected layers does not exclude other connections in which intervening elements may be present.

Moreover, the terms left, right, front, back, top, bottom, forward, reverse, clockwise and counterclockwise are used for purposes of explanation only and are not limited to any fixed direction or orientation. Rather, they are used merely to indicate relative locations and/or directions between various parts of an object and/or components.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the terms “including” and “having,” as well as other forms, such as “includes,” “included,” “has,” “have,” and “had,” should be considered non-exclusive. Also, terms such as “element” or “component” encompass both elements and components comprising one unit and elements and components that comprise more than one unit, unless specifically stated otherwise.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

In conventional approaches to intra prediction in VVC, MRL is disabled in CUs positioned at the top of a CTU to reduce implementation costs. MRL is further only applied when the intra prediction mode of a current prediction block is coded for MPM (not including planar mode). Specifically, when neighboring blocks (e.g., interpolation block, CU, another CTU, etc.) are outside of the CTU, they may not be used for intra prediction so that the line buffer size is not increased.

Thus, a more efficient coding framework for intra prediction with MRL is provided. Specifically, a sequence parameter set (SPS) syntax and corresponding framework for intra prediction with MRL are set forth.

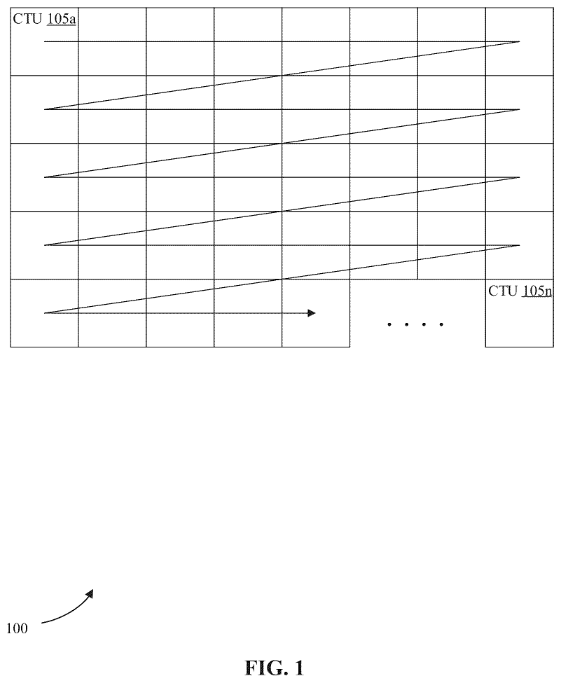

FIG. 1 is a schematic diagram of an image (e.g., frame 100) divided into blocks called coding tree units (CTUs). Accordingly, an image, such as a frame 100 of a video signal, may be divided into one or more CTUs 105a-105n (collectively CTUs 105). According to various embodiments, during coding, an input image (such as frame 100) may be divided into one or more CTUs 105a-105n. The CTUs 105 may cach individually be square blocks of pixels, as shown in FIG. 1. In some embodiments, an individual CTU of the CTUs 105 may be a block 128×128 luma pixels. In some embodiments, as depicted, frame 100 may be divided into CTUs 105. The one or more CTUs 105a-105n may, in some examples, be scanned in a raster scan order, as depicted. In other embodiments, a different scan order, such as a z-scan order, may be used. Each CTU 105a-105n of a frame 100 may respectively be partitioned into one or more CUs.

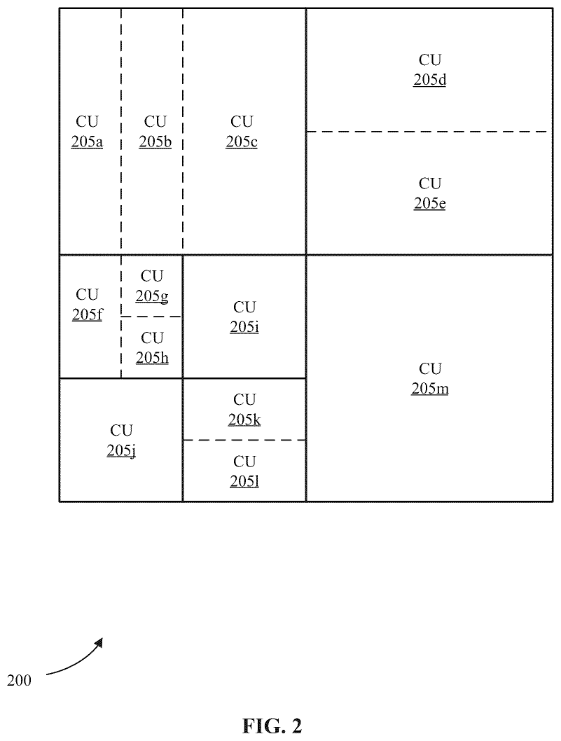

FIG. 2 is a schematic diagram of a CTU 200 divided into one or more coding units (CUs) 205a-205m (collectively CUs 205). In various embodiments, CUs 205 may be sub-units of a CTU, which may be used for prediction and transform during coding operations. CUs 205a-205m may be rectangular or square in arrangement, and further may be coded without further partitioning into prediction blocks or transform blocks. Each CU 205a-205m may be as large as its root CTU 200 and/or a subdivision of the CTU 200. For example, the CTU may be divided into subdivisions of up to 4×4 blocks (e.g., up to 16 total blocks). Thus, a CU 205, such as CU 205j, 205i may be the size of a single subdivision of the CTU 200. The CU 205 may further be smaller than the root CTU 200 and/or subdivision of the CTU 200, as shown by the CUs 205a-205h, 205k-205l. In some embodiments, the CUs 205a-205m may be coded, for example, in a Z-scan order, in the order labeled 205a-205m. It should be noted that the various CUs 205 of the CTU 200 are schematically illustrated in FIG. 2, and that modifications to the partitioning of a CTU 200 may be possible in accordance with the various embodiments.

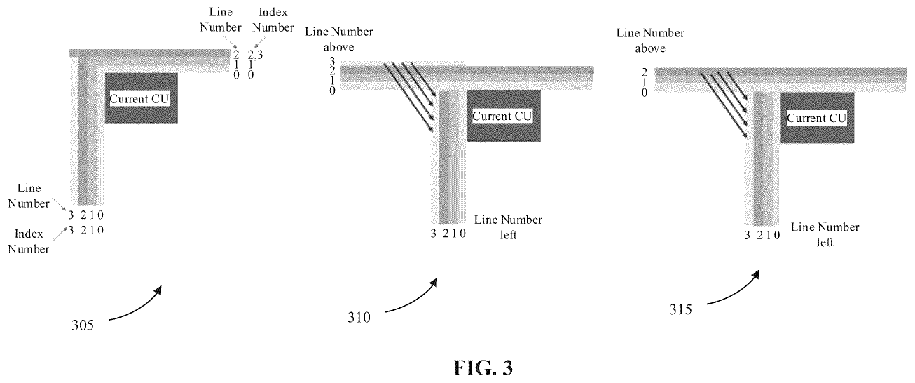

FIG. 3 is a schematic diagram of a framework for intra prediction with MRL, in accordance with various embodiments.

In conventional intra prediction, MRL may be enabled in sequence parameter set (SPS) per the following syntax elements set forth in Table 1.

TABLE 1
SPS Syntax for Enabling MRL

| | |
|---|---|
| seq_parameter_set_rbsp( ) { | Descriptor |
| ... | |
| sps_mrl_enabled_flag | u(1) |
| ... | |
| } | |

If the value of sps_mrl_enabled_flag is set to 1, a line for which intra prediction is applied may be specified utilizing the syntax shown in Table 2.

TABLE 2
Syntax for Specifying a Coding Unit

| | |
|---|---|
| coding_unit( x0, y0, cb Width, cbHeight, cqtDepth, treeType, modeType ) { | Descriptor |
| ... | |
| } else { | |
| if( sps_mrl_enabled_flag && ( ( y0 % CtbSizeY) > 0 ) ) | |
| intra_luma_ref_idx | ae(v) |
| ... | |
| } | |

For conventional angular intra prediction, the intra prediction mode predModeIntra may be transmitted through several syntax elements for each prediction block, and the associated parameter intraPredAngle may be obtained with as set forth in Table 3.

TABLE 3
Syntax for Angular Intra Prediction

| | | | | | | | | | | | | | | | | | |
|---|---|---|---|---|---|---|---|---|---|---|---|---|---|---|---|---|---|
| predModeIntra | −14 | −13 | −12 | −11 | −10 | −9 | −8 | −7 | −6 | −5 | −4 | −3 | −2 | −1 | 2 | 3 | 4 |
| intraPredAngle | 512 | 341 | 256 | 171 | 128 | 102 | 86 | 73 | 64 | 57 | 51 | 45 | 39 | 35 | 32 | 29 | 26 |
| predModeIntra | 5 | 6 | 7 | 8 | 9 | 10 | 11 | 12 | 13 | 14 | 15 | 16 | 17 | 18 | 19 | 20 | 21 |
| intraPredAngle | 23 | 20 | 18 | 16 | 14 | 12 | 10 | 8 | 6 | 4 | 3 | 2 | 1 | 0 | −1 | −2 | −3 |
| predModeIntra | 22 | 23 | 24 | 25 | 26 | 27 | 28 | 29 | 30 | 31 | 32 | 33 | 34 | 35 | 36 | 37 | 38 |
| intraPredAngle | −4 | −6 | −8 | −10 | −12 | −14 | −16 | −18 | −20 | −23 | −26 | −29 | −32 | −29 | −26 | −23 | −20 |
| predModeIntra | 39 | 40 | 41 | 42 | 43 | 44 | 45 | 46 | 47 | 48 | 49 | 50 | 51 | 52 | 53 | 54 | 55 |
| intraPredAngle | −18 | −16 | −14 | −12 | −10 | −8 | −6 | −4 | −3 | −2 | −1 | 0 | 1 | 2 | 3 | 4 | 6 |
| predModeIntra | 56 | 57 | 58 | 59 | 60 | 61 | 62 | 63 | 64 | 65 | 66 | 67 | 68 | 69 | 70 | 71 | 72 |
| intraPredAngle | 8 | 10 | 12 | 14 | 16 | 18 | 20 | 23 | 26 | 29 | 32 | 35 | 39 | 45 | 51 | 57 | 64 |
| predModeIntra | 73 | 74 | 75 | 76 | 77 | 78 | 79 | 80 | | | | | | | | | |
| intraPredAngle | 73 | 86 | 102 | 128 | 171 | 256 | 341 | 512 | | | | | | | | | |

When intraPredAngle is not equal to 0, the inverse angle parameter invAngle may be derived based on intraPredAngle as follows:

$$invAngle = Round ( \frac{512 * 32}{intraPredAngle} ) \qquad ( Eq . l )$$

When invAngle is less than 0, reference pixels are extended to the left and above neighboring pixels to generate the prediction samples.

Another conventional approach seeks to extended MRL by proposing an extended MRL list defined as N∈{1, 3, 5, 7, 12}, where the N is an integer, representing the (N+1) th reference line neighboring to the top and left of the CU. For Template-based Intra Mode Derivation (TIMD), the MRL list is N∈{1, 3}. The conventional extended MRL approach above results in an increase in line buffer size, which may impact cost and performance in hardware implementations.

Thus, in conventional intra prediction, MRL is not allowed at the top boundary of the CTU, which may reduce coding efficiency. Moreover, the optimal line index for the MRL intra prediction may differ between the above and the left neighbors. Thus, a separate reference lines may be supported to reference neighboring reference lines above and the neighboring reference lines to the left of the CU (e.g., prediction block) for which intra prediction is being applied. Moreover, when the encoder/decoder is implemented in software, inter slices may require more processing cycles, and even in inter slices there may be intra coding units. MRL intra prediction increases computational complexity. One conventional approach is disabling MRL entirely with SPS, but such solutions provide no intermediate solution between fully enabled MRL and fully disabled MRL.

For smaller prediction blocks, an increase in the number of the reference lines in MRL increases computational complexity in comparison to larger prediction blocks. Thus, in terms of coding efficiency, MRL benefits larger prediction blocks more than smaller prediction blocks. Moreover, with conventional MRL intra prediction, the number of allowed reference lines for prediction is fixed regardless of the block size.

Thus, a framework for intra prediction with MRL is set forth with respect to FIG. 3. In various embodiments, the number of above-neighboring reference lines (referred to herein as “above neighbors”) may be kept the same, while four additional reference lines neighboring to the left (referred to herein as “left neighbors”) may be added for intra prediction. This is depicted with respect to the schematic diagram 305 of the prediction block, above neighbors, and left neighbors. Thus, above neighbors may retain line numbers 2, 1, 0, while the left neighbors are assigned line numbers 3, 2, 1, and 0. In some examples, where the value of intra_luma_ref_idx is 3, the index value of 3 may refer to the left neighbor corresponding to a selection of line number 3 as a candidate reference line. The same index value of 3 may be used to refer to an above neighbor corresponding to line number 2, as there is no additional above neighbor beyond line number 2. In this example, both index values of 2 and 3 correspond to above neighbor line number 2. Thus, this scheme may be implemented with no increase in line buffer size. In this way, an MRL index (c.g., intra_luma_ref_idx) may be used to select one or more candidate reference lines for MRL intra prediction (e.g., left neighbor reference lines and above neighbor reference lines). As used herein, the MRL index may be a value used to specify one or more candidate reference lines from neighboring reference lines to be used for intra prediction.

In further embodiments, in the case of angular intra prediction, where invAngle<0, left neighboring pixels may be obtained as depicted in schematic diagram 310, without increasing line buffer size. For example, assuming the value of intra_luma_ref_idx is 3, if the pixels in the above neighboring reference line (e.g., above neighbor) associated with line number 3 (also referred to as “line number above 3”) are mapped to the left neighboring reference line (e.g., left neighbor) corresponding to line number 3 (also referred to as “line number left 3”), an additional line buffer would be utilized. Thus, to implement this without increasing the buffer size, a scheme as depicted in schematic diagram 315 may be adopted. Specifically, pixels in the above neighbor associated with line number 2 (e.g., line number above 2) may be mapped to the left neighbor associated with line number 3 (e.g., line number left 3). Thus, no extra line buffer would be needed.

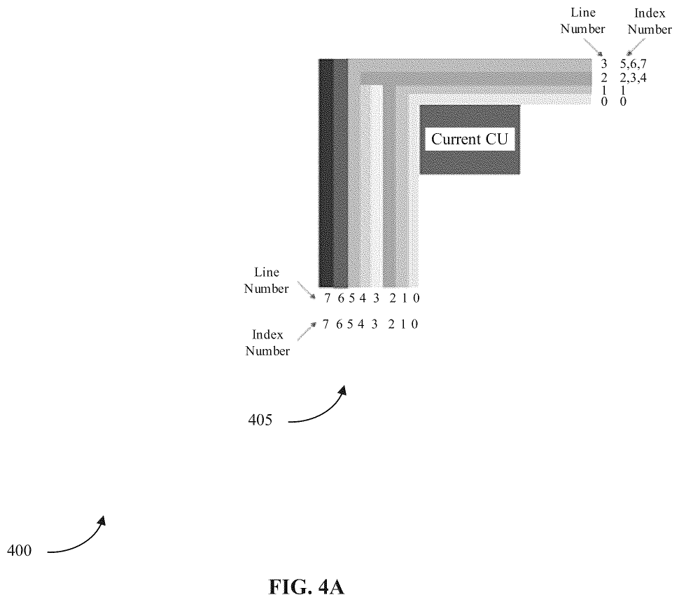

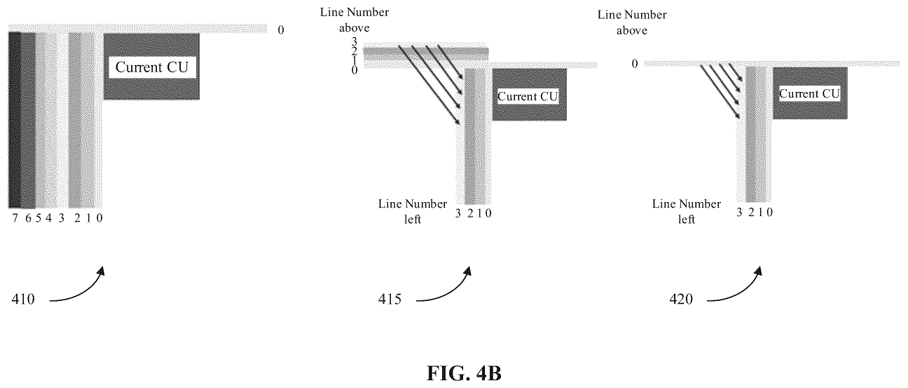

FIG. 4A is a schematic diagram 400 of an alternative scheme 400 for intra prediction with MRL with increased buffer lines, in accordance with various embodiments. In some embodiments, to extend MRL, the line buffer may be increased slightly. In the embodiment depicted, there may be 8 candidate reference lines as left neighbors and 4 candidate reference lines as above neighbors. Continuing with the previous example, when intra_luma_ref_idx is set to 3, line number 3 may be selected as the left neighbor (e.g., line number left 3), while the line number 2 is used as the above neighbor (e.g., line number above 2). Specifically, index values 2-4 may correspond to an above neighbor line number 2 (e.g., line number above 2), while index values 5-7 correspond to an above neighbor line number 3 (e.g., line number above 3). In contrast, left neighbor line numbers 0-7 may respectively correspond to index values 0-7.

In further examples, the above may be applied to examples where the CU (e.g., prediction block), to which intra prediction is applied, is positioned such that a top of the CU is positioned at the boundary between the CTU to which the CU belongs, and a neighboring (at the top edge) CTU.

FIG. 4B is a schematic diagram of intra prediction with MRL at a top boundary of a CTU, in accordance with various embodiments. At the top boundary of a CTU, neighboring pixels of the current CU are shown in schematic diagram 410. Thus, schematic diagram 410 illustrates the positioning of the CU, in which a top edge of the CU is on the top boundary of a respective CTU.

The MRL with extended left lines are applied when these lines are available in the current picture. In some examples, intra_luma_ref_idx may be transmitted even with the top boundary of a CTU. Continuing with the previous example, when intra_luma_ref_idx is set to 3 for this current CU, a left neighbor line number 3 (e.g., line number left 3) and an above neighbor line number 0 (e.g., line number above 3) may be used for intra prediction.

In some further examples, where invAngle<0, left neighboring pixels may be obtained as depicted in schematic diagram 420 to avoid increases in line buffer at the top CTU boundary. In this case only one line from the top is used both as the above and the left neighbors.

Continuing with the previous example, when intra_luma_ref_idx is set to 3, under conventional enhanced compression model (ECM) depicted in schematic diagram 415, the pixels in line number 3 of the above neighbor (e.g., line number above 3) may be mapped to the pixels in line number 3 of the left neighbors (e.g., line number left 3). Thus, under conventional ECM, it is necessary to store 4 lines above the top of the CTU boundary in the line buffer.

According to various embodiments of the intra prediction framework, it is proposed to map the pixels of line number 0 of the above neighbors (e.g., line number above 0) into the pixels of the line number left 3. In this way, no increase to the line buffer above the top CTU boundary may be needed.

The proposed SPS syntax changes associated with schematic diagrams 410 and 420 are set forth in Table 4 below. Specifically, in various embodiments, the syntax element intra_luma_ref_idx may be configured to specify which line in the left neighbor is used as the reference line, as shown in schematic diagram 420. In this example, when the current CU is located at a top boundary of the CTU, the reference line for the above neighbor is always 0 regardless of the value of the syntax element intra_luma_ref_idx. In some further examples, for CUs which are not located at the top boundary of the CTU, the reference line for the MRL intra prediction may be specified in a similar manner to the VVC specification.

TABLE 4
Syntax for supporting CU at Top Boundary of CTU

| | |
|---|---|
| coding_unit( x0, y0, cbWidth, cbHeight, cqtDepth, treeType, modeType ) { | Descriptor |
| ... | |
| } else { | |
| if( sps_mrl_enabled_flag [symbol] | |
| intra_luma_ref_idx | ae(v) |
| ... | |
| } | |

In yet further embodiments, the intra prediction with MRL framework may allow reference lines to be specified independently. Specifically, the syntax of coding_unit( ) may be modified as shown in Table 5, which allows for specifying the reference lines from above neighbors and left neighbors independently.

Some intra angular prediction modes, for example the pure horizontal prediction mode, may use left neighbors only, and not above neighbors. In this case, only intra_luma_left_ref_idx is transmitted and intra_luma_above_ref_idx is not transmitted. Alternatively, both intra_luma_above_ref_idx and intra_luma_left_ref_idx are transmitted, but the value of intra_luma_above_ref_idx shall be set to 0.

Similarly, some intra angular prediction modes, for example pure vertical prediction mode, may use above neighbors only, and not left neighbors. In this case, only intra_luma_above_ref_idx is transmitted and intra_luma_left_ref_idx is not transmitted. Alternatively, both intra_luma_above_ref_idx and intra_luma_left_ref_idx are transmitted, but the value of intra_luma_left_ref_idx shall be set to 0.

TABLE 5
Syntax for Independent Specification of Reference Lines

| | |
|---|---|
| coding_unit( x0, y0, cbWidth, cbHeight, cqtDepth, treeType, modeType ) { | Descriptor |
| ... | |
| } else { | |
| if( sps_mrl_enabled_flag && ( ( y0 % CtbSizeY) > 0 ) ) | |
| intra_luma_above_ref_idx | ae(v) |
| intra_luma_left_ref_idx | ae(v) |
| ... | |
| } | |

In various embodiments, the number of lines allowed for MRL may differ between intra and inter slices. For example, in some embodiments, fewer reference lines may be allowed with inter slices so that further increase in computational complexity can be avoided. In some examples, the SPS syntax of intra_luma_ref_idx is the same for both intra and inter slices, however the max value may be different. For example, a smaller max value may be defined for inter slices than that for intra slices to decrease computational cost without losing coding efficiency.

Increasing the number of reference lines may result in an increase in the computational complexity especially with smaller prediction blocks. Therefore, in various examples, a different number of the reference lines may be used for intra prediction based on a prediction block size (e.g., CU size) For example, in some embodiments, a total of 8 reference lines may be used for CUs bigger than 16×16. In further examples, a total of 3 reference lines may be used for CUs with sizes equal to 4×4 and 8×8.

In various embodiments, the syntax of intra_luma_ref_idx may be the same for all the prediction block sizes, but the max value may be different. For example, a smaller max value may be defined for smaller prediction blocks, and relatively larger max values may be set for large prediction blocks to decrease computational cost without losing coding efficiency.

To provide flexible encoder/decoder implementation trade-offs between coding efficiency and cost, various embodiments also set forth syntax elements to specify the maximum number of lines for the MRL intra prediction in SPS or in Slice Header (SH), as shown in Table 6 and Table 7, respectively. In yet further examples, in SPS, the values of the syntax elements mrl_max_above_lines_minus1 and mrl_max_left_lines_minus1 may be specified for intra and inter slices separately.

TABLE 6
SPS Syntax to Specify Maximum Number of Lines for MRL

| | |
|---|---|
| seq_parameter_set_rbsp( ) { | Descriptor |
| ... | u(1) |
| sps_mrl_enabled_flag | u(1) |
| if( sps_mrl_enabled_flag ){ | |
| sps_mrl_max_above_lines_minus1 | ue(v) |
| sps_mrl_max_left_lines_minus1 | ue(v) |
| } | |
| ... | |
| } | |

TABLE 7
SH Syntax to Specify Maximum Number of Lines for MRL

| | |
|---|---|
| slice_header( ) { | Descriptor |
| ... | |
| if( sps_mrl_enabled_flag ){ | |
| sh_mrl_max_above_lines_minus1 | ue(v) |
| sh_mrl_max_left_lines_minus1 | ue(v) |
| } | |
| ... | |
| } | |

In yet further embodiments, MRL may be extended to apply to various intra prediction modes, and specifically, to primary MPM and secondary MPM intra prediction modes. As previously described, conventional ECM models do not support intra prediction for blocks coded with secondary MPM. According to various embodiments, intra prediction may be extended to secondary MPM via a coding_unit( ) syntax as set forth in Table 8. Specifically, in various embodiments, the intra_luma_mpm_flag may be transmitted regardless of the value of intra_luma_ref_idx. If the value of intra_luma_mpm_flag is 0, intra_luma_second_mpm_flag may be transmitted when the value of intra_luma_ref_idx is equal to 0. If the value of intra_luma_ref_idx is not equal to 0, MRL intra prediction may be applied and the syntax element intra_luma_second_mpm_flag is no longer transmitted (e.g., as set forth in conventional ECM), as the value can be inferred to be 1. intra_luma_second_mpm_flag may be transmitted when the value of intra_luma_ref_idx is equal to 0.

TABLE 8
Syntax for Intra Prediction with MRL in Secondary MPM Mode Coding

| | |
|---|---|
| coding_unit( x0, y0, cbWidth, cbHeight, cqtDepth, treeType, modeType ) { | Descriptor |
| ... | |
| if( sps_mrl_enabled_flag && ( ( y0 % CtbSizeY) > 0 ) ) | |
| intra_luma_ref_idx | ae(v) |
| ... | |
| intra_luma_mpm_flag[ x0 ][ y0 ] | ae(v) |
| if( !intra_luma_mpm_flag[ x0 ][ y0 ] ) | |
| if( intra_luma_ref_idx == 0 ) | |
| intra_luma_second_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else if( intra_luma_second_mpm_flag[ x0 ][ y0 ] ) | |
| intra_luma_second_mpm_[ x0 ][ y0 ] | ae(v) |
| else | |
| intra_luma_mpm_remainder[ x0 ][ y0 ] | ae(v) |
| ... | |
| } | |

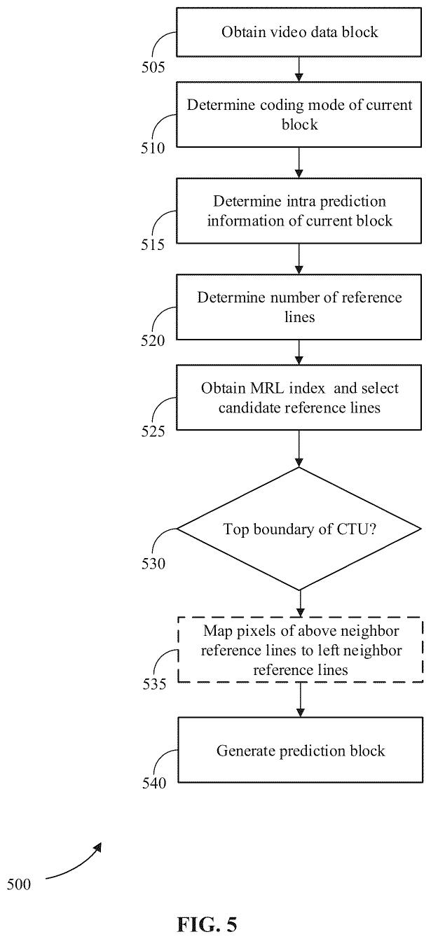

FIG. 5 is a flow diagram of a method 500 for intra prediction with MRL, in accordance with various embodiments. The method 500 begins, at block 505, by obtaining a video data block. As previously described, in some embodiments, a block of video data may include, without limitation, a CTU, subdivision of a CTU, or CU. The block of video data may further include transformed and/or non-transformed video data.

At block 510, the method 500 continues by determining a coding mode of a current block of the video data block. The coding mode of the current block of the video data may include, for example, a PMPM or a SMPM coding mode. As previously described, in some examples, MRL may be enabled for both PMPM and SMPM coding modes, excluding planar mode.

The method 500 continues, at block 515, by determining intra prediction information for the current block from the bitstream of the video data. The intra prediction information may include a plurality of syntax elements obtained from a bitstream of the current block. The syntax elements may include, in some examples, SPS, SH, or other suitable types of syntax elements. In some examples, determining intra prediction information may further include determining an intra prediction mode (e.g., angular intra prediction mode, PMPM, SMPM mode, etc.). In some embodiments, determining intra prediction information may include decoding a bit stream and determining the intra prediction information from the decoded bit stream. In some examples, the intra prediction information may be determined based on one or more syntax elements decoded from the bit stream. As used herein, decoding the one or more syntax elements from the bit stream may include extracting one or more syntax elements from the decoded bit stream.

At block 520, the method 500 includes determining a number of left neighbor reference lines and above neighbor reference lines. In some examples, the number of neighboring reference lines in the left neighbor and above neighbor may be specified via separate syntax elements for left and above neighbor reference lines. As previously described, in some embodiments, specifying the number of left and above neighbor reference lines may include specifying a maximum number of reference lines. For example, in some embodiments, a syntax element “sps_mrl_max_above_lines_minus1” may specify a maximum number of above neighbor reference lines, and “sps_mrl_max_left_lines_minus1” may specify a maximum number of left neighbor reference lines. In some further examples, as previously described, a number of reference lines may be determined based on the size of a current block/prediction block. In yet further embodiments, a number of reference lines may be determine, at least in part, by whether the video data block is part of an intra slice or inter slice, as previously described.

At block 525, the method 500 further includes obtaining an MRL index for intra prediction. An MRL index may be given by a syntax element, for example, intra_luma_ref_idx. As previously described, the MRL index may specify one or more candidate reference lines from neighboring reference lines to be used for intra prediction. In some embodiments, obtaining the MRL index may include decoding a bit stream, and from the decoded bit stream, determining an MRL index. In some examples, the MRL index may be determined based on a syntax element decoded from the bit stream. Depending on the position of the CU, size of the CU, and other parameters specified by the syntax elements, different MRL indices may be related to different combinations of left neighbor reference lines and above neighbor reference lines. In some embodiments, where a different number of above neighbor reference lines and left neighbor reference lines are used, an MRL index value may correspond to a different reference line number (e.g., a line number above and line number left). For example, an MRL index may have values between 0-7, and there may be a total of 8 left neighbor reference lines (line number left 0-7), and a total of 4 above neighbor reference lines (line number above 0-3). In some examples, the MRL index value may correspond to a respective line number left (e.g., MRL index 0 corresponds to line number left 0, MRL index 1 corresponds to line number left 1, etc.) as a candidate reference line. With respect to above neighbor reference lines, a range of MRL index values may correspond to a single above neighbor reference line. For example, an MRL index 0 may correspond to line number above 0, MRL index 1 to line number above 1, and MRL index values 2-4 to line number above 2, and MRL index values 5-7 to line number above 3 (which may then be selected as candidate reference lines). It is to be understood that in other embodiments, a different correspondence between MRL index and line number may be used and embodiments are not limited to any particular relationship between MRL index and line number. In yet further embodiments, an MRL index may independent specify a left neighbor reference line and an above neighbor reference line via separate syntax elements. For example, in some embodiments, an MRL index syntax clement “intra_luma_above_ref_idx” may be an MRL index for specifying an above neighbor reference line, and “intra_luma_left_ref_idx” may be an MRL index for specifying a left neighbor reference line. Thus, in some embodiments, selecting a candidate reference line may include first decoding the respective candidate reference line to be used for intra prediction. For example, in some embodiments, selecting a candidate reference line, based on the MRL index, may include decoding a first candidate reference of a set of one or more above neighboring reference lines and a second candidate reference line from a set of one or more left neighboring reference lines, based on the MRL index.

At block 530, the method 500 further includes determining whether the current block is at a top boundary of CTU. At block 535, the method 500 further includes mapping pixels of above neighbor reference lines to left neighbor reference lines when angular intra prediction is applied. If it is determined that the current block is positioned at a top boundary of the CTU (e.g., a boundary at the top of the CTU with a neighboring CTU), a corresponding pixel mapping scheme may be adopted for MRL intra prediction, as previously described. In other embodiments, when a different number of above neighbor and left neighbor reference lines are used, an above reference line specified by the MRL index may be mapped to a corresponding left reference line specified by the MRL index (e.g., a single MRL index may be used to indicate both left and above neighbor reference lines, or separate respective MRL indices for above neighbor reference lines and left neighbor reference lines may be used). At block 540, the method 500 further includes generating a prediction block based on the intra prediction according to syntax elements.

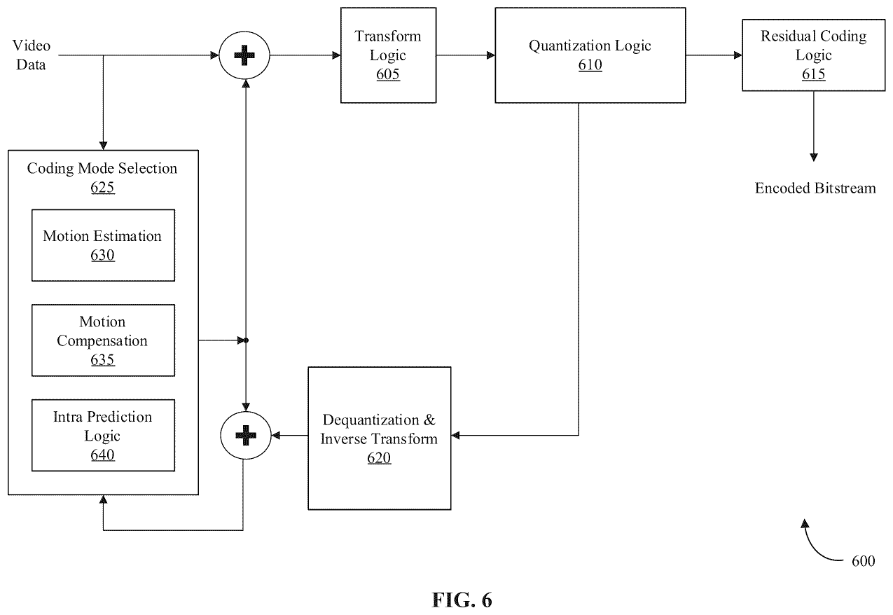

FIG. 6 is a block diagram of a media encoding system 600, in accordance with various embodiments. The media encoding system 600 may include transform logic 605, quantization logic 610, residual coding logic 615, dequantization and inverse transform logic 620, and coding mode selection logic 625, which may include motion estimation logic 630, motion compensation logic 635, and prediction logic 640. It should be noted that the various components of the media encoding system 600 are schematically illustrated in FIG. 6, and that modifications to the media encoding system 600 may be possible in accordance with the various embodiments.

In various embodiments, the media encoding system 600 may be implemented on any suitable hardware, such as one or more microprocessors, digital signal processors (DSP), application specific integrated circuits (ASICs), field programmable gate arrays (FPGAs), discrete logic, software, hardware, or a combination of software and hardware. Features and logic implemented in software may be stored in corresponding non-transitory computer-readable media and/or storage devices. This is discussed in greater detail below with respect to FIG. 9.

In various embodiments, the video data may include an image (e.g., a frame) of the video data, also referred to as a block or macroblock (e.g., CTU). The video data may be provided to the coding mode selection logic 625, which may be configured to produce a predicted image (c.g., a prediction block) utilizing intra prediction logic 640.

In various embodiments, the coding mode selection logic 625 may be configured to specify a coding mode. As previously described, the coding mode may include specifying an intra coding mode, such as MPM (c.g., a PMPM, SMPM, etc.) or angular intra coding. Based on the coding mode, an intra prediction logic 640 may perform intra prediction with MRL as described above with respect to FIGS. 3-5.

Specifically, in various embodiments, intra prediction logic 640 may be configured to determine a position of the prediction block (e.g., CU) for which intra prediction is being performed.

In some embodiments, the predicted image may be subtracted from an actual subsequent image of the frame to produce a residual frame (e.g., a residual block), and transform logic 605 may transform the residual block to produce a block of transformed video data from the residual frame. The block of transformed video data may be provided to the quantization logic 610. In other examples, the video data may be provided directly to the quantization logic 610, without undergoing transformation. As previously described, in some examples, a block may include a CTU, subdivision of a CTU, or CU.

Quantization logic 610 may be configured to quantize the transformed or non-transformed video data to produce a block of quantization levels. The quantization logic 610 may, in some examples, produce sets of quantization levels. In some embodiments, the quantized block may be processed by the residual coding logic 615. The residual coding logic 615 may be configured to convert the data of the quantized block into an encoded bit stream.

In some embodiments, the quantized block may further be provided to the dequantization & inverse transform logic 620 for further processing. For example, in some embodiments, the dequantization and inverse transform logic may be used to generate a reconstructed residual block. The reconstructed residual block may be added to the next predicted frame and used for motion estimation logic 630, motion compensation logic 635, and prediction logic 640 to produce a prediction block.

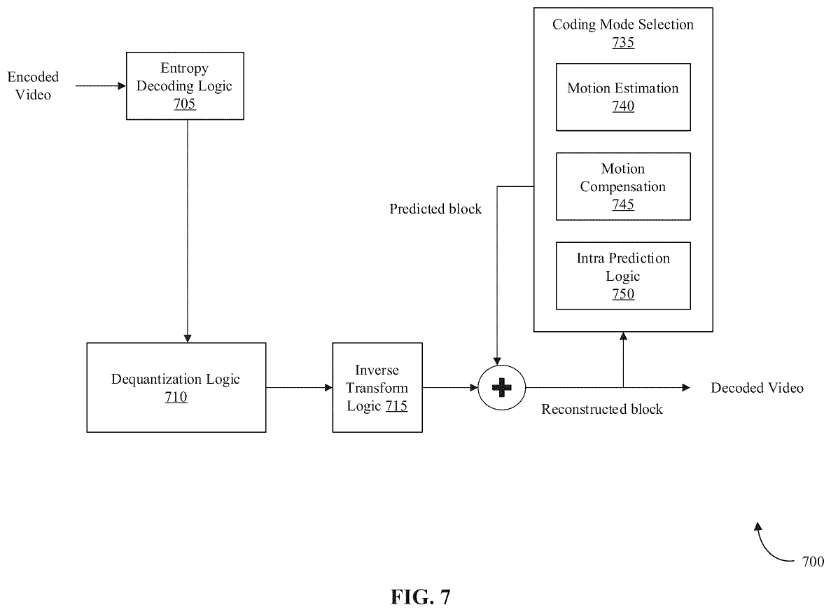

FIG. 7 is a block diagram of a media decoding system 700, in accordance with various embodiments. The media decoding system 700 may include entropy decoding logic 705, dequantization logic 710, inverse transform logic 715, coding mode selection logic 720, motion estimation logic 725, motion compensation logic 730, and intra prediction logic 735. It should be noted that the various components of the media decoding system 700 are schematically illustrated in FIG. 7, and that modifications to the media encoding system 700 may be possible in accordance with the various embodiments.

In various embodiments, like the media encoding system 600, the media decoding system 700 may be implemented on any suitable hardware, such as one or more microprocessors, DSP, ASIC, FPGA, discrete logic, software, hardware, or a combination of software and hardware. In various embodiments, the encoded video data may include a bit stream of encoded video blocks. Accordingly, entropy decoding logic 705 may be configured to decode the encoded bit stream of video data. Specifically, the encoded bit stream may be decoded and quantized elements extracted from the encoded bit stream for further processing.

In some examples, the quantized elements may then be inverse quantized (or dequantized) by the dequantization logic 710. The inverse transform logic 715 may inverse transform the coefficient produced by the dequantization logic 710. In some examples, for blocks where the transform is skipped, the inverse transform module is not applied to those blocks.

In further examples, the residual block, produced by the dequantization logic 710 may be added to a corresponding prediction block, produced by the coding mode selection logic 720, to generate a reconstructed block. The reconstructed block may then be provided to the coding mode selection logic 720 to produce a subsequent prediction block. Thus, the de-quantized clements produced by the dequantization logic 710 may be used to generate the reconstructed block, with a decoded video may be produced. As discussed above with respect to FIG. 6, the prediction block may be generated according to a coding mode and intra prediction parameters of the block, and according to motion estimation logic 725, motion compensation logic 730, and intra prediction logic 735. As previously described, the selecting a coding mode may include specifying an intra coding mode, such as angular intra prediction mode. Thus, the intra prediction logic 735 may be configured to perform intra prediction with MRL as described above with respect to FIGS. 3-5, based on the prediction mode.

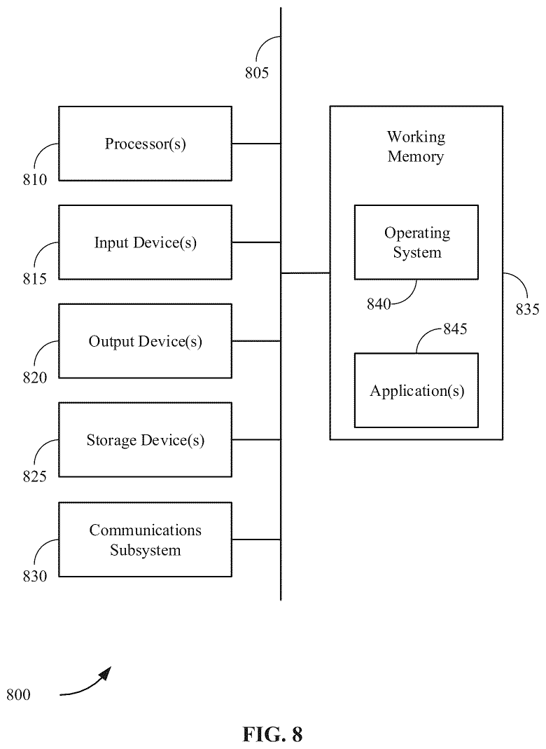

The techniques and processes described above with respect to various embodiments may be performed by one or more computer systems. FIG. 8 is a schematic block diagram of a computer system 800 for intra prediction with MRL, in accordance with various embodiments. FIG. 8 provides a schematic illustration of one embodiment of a computer system 800, such as in media coding systems 600, 700, or subsystems thereof, which may perform the methods provided by various other embodiments, as described herein. It should be noted that FIG. 8 only provides a generalized illustration of various components, of which one or more of each may be utilized as appropriate. FIG. 8, therefore, broadly illustrates how individual system elements may be implemented in a separated or integrated manner.

The computer system 800 includes multiple hardware elements that may be electrically coupled via a bus 805 (or may otherwise be in communication, as appropriate). The hardware elements may include one or more processors 810, including, without limitation, one or more general-purpose processors and/or one or more special-purpose processors (such as microprocessors, digital signal processor (DSP) including vector DSP (VDSP), graphics processing units, and microcontrollers); one or more input devices 815, which include, without limitation, a mouse, a keyboard, one or more sensors, and/or the like; and one or more output devices 820, which can include, without limitation, a display device, and/or the like.

The computer system 800 may further include (and/or be in communication with) one or more storage devices 825, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 800 might also include a communications subsystem 830, which may include, without limitation, a modem, a network card (wireless or wired), an IR communication device, a wireless communication device and/or chipset (such as a Bluetooth™ device, an 802.11 device, a WiFi device, a WiMax device, a WWAN device, a Z-Wave device, a ZigBee device, cellular communication facilities, etc.), and/or a low-power wireless device. The communications subsystem 830 may permit data to be exchanged with a network (such as the network described below, to name one example), with other computer or hardware systems, between data centers or different cloud platforms, and/or with any other devices described herein. In many embodiments, the computer system 800 further comprises a working memory 835, which can include a RAM or ROM device, as described above.

The computer system 800 also may comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 825 described above. In some cases, the storage medium might be incorporated within a computer system, such as the system 800. In other embodiments, the storage medium might be separate from a computer system (i.c., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 800) to perform methods in accordance with various embodiments of the invention. According to a set of embodiments, some or all of the procedures of such methods are performed by the computer system 800 in response to processor 810 executing one or more sequences of one or more instructions (which may be incorporated into the operating system 840 and/or other code, such as an application program 845) contained in the working memory 835. Such instructions may be read into the working memory 835 from another computer readable medium, such as one or more of the storage device(s) 825. Merely by way of example, execution of the sequences of instructions contained in the working memory 835 might cause the processor(s) 810 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various computer readable media might be involved in providing instructions/code to processor(s) 810 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 825. Volatile media includes, without limitation, dynamic memory, such as the working memory 835. In some alternative embodiments, a computer readable medium may take the form of transmission media, which includes, without limitation, coaxial cables, copper wire and fiber optics, including the wires that comprise the bus 805, as well as the various components of the communication subsystem 830 (and/or the media by which the communications subsystem 830 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals, and/or the like, are all examples of carrier waves on which instructions can be encoded, in accordance with various embodiments of the invention.

The communications subsystem 830 (and/or components thereof) generally receives the signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a storage device 825 either before or after execution by the processor(s) 810.

While some features and aspects have been described with respect to the embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while some functionality is ascribed to one or more system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with or without some features for ease of description and to illustrate aspects of those embodiments, the various components and/or features described herein with respect to a particular embodiment can be substituted, added and/or subtracted from among other described embodiments, unless the context dictates otherwise. Consequently, although several embodiments are described above, it will be appreciated that the invention is intended to cover all modifications and equivalents within the scope of the following claims.

What is claimed is:

1. A method comprising:
determining intra prediction information of a current block, wherein the intra prediction information includes a plurality of syntax elements;
obtaining a multiple reference line (MRL) index from the plurality of syntax elements;
decoding a first candidate reference line and a second candidate reference line based, at least in part, on the MRL index, wherein the first candidate reference line is one of a set of one or more above neighboring reference lines, wherein the second candidate reference line is one of a set of one or more left neighboring reference lines; and
generating a prediction block based, at least in part, on intra prediction performed based on the plurality of syntax elements. cm 2. The method of claim 1, wherein determining intra prediction information includes determining an intra prediction mode of the current block.

3. The method of claim 2, wherein the intra prediction mode is an angular intra prediction mode.

4. The method of claim 3, wherein the intra prediction mode is one of a primary most probable mode or secondary most probable mode, excluding planar mode.

5. The method of claim 1, further comprising:
determining a maximum number of reference lines to be used for intra prediction based on the plurality of syntax elements.

6. The method of claim 5, wherein determining the maximum number of reference lines further comprises:
determining a maximum number of reference lines in the set of one or more above neighboring reference lines; and
determining a maximum number of reference lines in the set of one or more left neighboring reference lines.

7. The method of claim 1, wherein the MRL index further comprises an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines.

8. The method of claim 1, wherein a first range of MRL index values corresponds to the first candidate reference line.

9. A non-transitory computer readable medium in communication with a processor, the non-transitory computer readable medium having encoded thereon a set of instructions executable by the processor to:
determine intra prediction information of a current block, wherein the intra prediction information includes a plurality of syntax elements;
obtain a multiple reference line (MRL) index from the plurality of syntax elements;
decode a first candidate reference line and a second candidate reference line based, at least in part, on the MRL index, wherein the first candidate reference line is one of a set of one or more above neighboring reference lines, wherein the second candidate reference line is one of a set of one or more left neighboring reference lines; and
generate a prediction block based, at least in part, on intra prediction performed based on the plurality of syntax elements.

10. The non-transitory computer readable medium of claim 9, wherein determining intra prediction information includes determining an intra prediction mode of the current block.

11. The non-transitory computer readable medium of claim 10, wherein the intra prediction mode is an angular intra prediction mode, wherein the set of instructions is further executable by the processor to:
map pixels of the first candidate reference line to the second candidate reference line.

12. The non-transitory computer readable medium of claim 10, wherein the intra prediction mode is one of a primary most probable mode or secondary most probable mode, excluding planar mode.

13. The non-transitory computer readable medium of claim 9, wherein the set of instructions is further executable by the processor to:
determine a maximum number of reference lines to be used for intra prediction based on the plurality of syntax elements.

14. The non-transitory computer readable medium of claim 13, wherein determining the maximum number of reference lines further comprises:
determining a maximum number of reference lines in the set of one or more above neighboring reference lines; and
determining a maximum number of reference lines in the set of one or more left neighboring reference lines.

15. The non-transitory computer readable medium of claim 9, wherein the MRL index further comprises an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines.

16. The non-transitory computer readable medium of claim 9, wherein a first range of MRL index values corresponds to the first candidate reference line.

17. A video coding system comprising:
at least one of an encoder or decoder, wherein the at least one of the encoder or decoder comprises:
a processor;
a non-transitory computer readable medium in communication with the processor, the non-transitory computer readable medium having encoded thereon a set of instructions executable by the processor to:
determine intra prediction information of a current block, wherein the intra prediction information includes a plurality of syntax elements;
obtain a multiple reference line (MRL) index from the plurality of syntax elements;
select a first candidate reference line and a second candidate reference line based, at least in part, on the MRL index, wherein the first candidate reference line is one of a set of one or more above neighboring reference lines, wherein the second candidate reference line is one of a set of one or more left neighboring reference lines; and
generate a prediction block based, at least in part, on intra prediction performed based on the plurality of syntax elements.

18. The video coding system of claim 17, wherein the intra prediction mode is a secondary most probable mode.

19. The video coding system of claim 17, wherein the MRL index further comprises an above MRL index corresponding to the first candidate reference line, and a left MRL index corresponding to the second candidate reference line, wherein the above MRL index independently specifies a first respective reference line of the one or more above neighboring reference lines, and wherein the left MRL index independently specifies a second respective reference line one or more left neighboring reference lines.

20. The video coding system of claim 17, wherein a first range of MRL index values corresponds to the first candidate reference line.
